(19) United States
(12) Patent Application Publication
(10) Pub. No.: US 2024/0372365 A1
(43) Pub. Date: Nov. 7, 2024

(54) METHOD AND SYSTEM FOR AN ELECTRICITY DISTRIBUTION LINE

(71) Applicant: Alberto BAUER, Al Menara (AE)

(72) Inventor: Alberto BAUER, Al Menara (AE)

(21) Appl. No.: 18/688,782

(22) PCT Filed: Sep. 15, 2022
(86) PCT No.: PCT/IT2022/000049

§ 371 Date: Mar. 3, 2024

(30) Foreign Application Priority Data
Sep. 24, 2021 (IT) 102021000024534

(51) Int. Cl. H02J 3/06; H02J 13/00

(52) U.S. Cl. CPC H02J 3/06; H02J 13/00002; H02J 2203/10

(57) ABSTRACT

A method relating to a system for a line for the distribution of electrical energy comprises: a primary substation (CP) comprising a conductor (11), an HV/MV voltage transformer (12), a second conductor 13, a busbar (14), an initial portion of a first distribution line (L 1.MT), a measurement voltage transformer (15), a first current transformer (16) and a first PMU (51); a first medium voltage distribution line (Ll.MT); a first secondary substation (CS.100) comprising a third conductor (110), a second current transformer (116), a first voltage reduction apparatus (120) and a second PMU (151); and a second secondary substation (CS.200) comprising a fourth conductor (210), a second voltage reduction apparatus (230) and a third PMU (251); wherein said system comprises a receiving processing unit (UR); and wherein said method provides for carrying out operations in order to perform a calibration in relation to the first (120) and second (230) voltage reduction apparatus. A related system.

### TECHNICAL FIELD

The present invention concerns the sector of lines for the distribution of electrical energy and, more particularly, in the sector of diagnostics for said lines.

### BACKGROUND OF THE INVENTION

Currently, methods and systems relating to lines for the distribution of electrical energy are known.

Said methods and systems have a series of drawbacks.

A first drawback is due to the fact that they do not allow to execute an accurate diagnostics in relation to the line as a whole and/or in relation to pieces of the same line and/or in relation to one or more of the devices connected to it, such as, for example, performing a calibration of the voltage reduction devices during the operation of the line, that is, with the line energized.

A second drawback is due to the fact that they require the use in the line of multiple devices and multiple apparatuses with consequent set up and maintenance costs. A third drawback is due to the fact that they do not allow to modify an existing line system, in which it is not possible to carry out the diagnostics of the devices, in a line system in which it is possible to carry out the diagnostics of the pre-existing line and/or the diagnostics of the related apparatuses already present, such as, for example, obtaining a line in which it is possible to perform the calibration of the voltage reduction apparatuses, without, for example, having to install measurement voltage transformers in each of the individual secondary substations.

### DESCRIPTION OF THE INVENTION

The purpose of the present invention is therefore to solve the aforementioned drawbacks.

The invention, which is characterized by the claims, solves the problem of creating a Method relating to a system of a line for the distribution of electricity comprising one primary substation, a first distribution line in medium voltage, a first secondary substation and at least a second secondary substation; in which said primary substation (CP) comprises: a first high voltage conductor; a HV/MV voltage transformer suitable for transforming the high voltage electrical energy coming from said first conductor into medium voltage electrical energy; a second medium voltage conductor as an output conductor from said HV/MV voltage transformer; a medium voltage busbar connected to said second medium voltage conductor; the initial portion of said first voltage medium distribution line as output line from said primary substation and connected to said voltage medium busbar; a measuring voltage transformer connected to the second conductor and suitable for measuring the output voltage from said HV/MV voltage transformer; a first current transformer connected to the first line of medium voltage in an initial zone of the same first line and able to detect the current at the beginning of said first line of medium voltage; a first PMU connected to the output of said measurement voltage transformer and connected to the output of said first current transformer; in which said first secondary substation comprises: a third conductor in medium voltage as input conductor in said first secondary substation and connected to the aforementioned first distribution line; a second current transformer connected to the first line of medium voltage in a zone between the first secondary substation and the second secondary substation and able to detect the current along said first line of medium voltage; a first voltage reduction apparatus connected to said third conductor and able to measure the voltage entering the first secondary substation; a second PMU connected to the output of said second current transformer and to the output of said first voltage reduction apparatus; in which said second secondary substation comprises: a fourth conductor in medium voltage as input conductor in the second secondary substation and connected to the aforementioned first distribution line; a second voltage reducing apparatus connected to said fourth voltage medium input conductor; a third PMU connected to the outlet of said second voltage reduction apparatus located in said second secondary substation; in which said system comprises a receiving-processing unit able to receive and to process the data transmitted by the first PMU located in the primary substation, by the second PMU located in the first secondary substation and by the third PMU located in the second secondary substation; in which said METHOD is characterized by the fact that to comprises the following operations: m.1a) to detect by means of the first PMU located in the first primary substation at certain instants of time the values of voltage at the output of the measurement voltage transformer located in the primary substation and transmit the relative data with relative time references to the receiving-processing unit; m.1b) to detect by means of the first PMU located in said primary substation at certain instants of time which are the same instant of times of the previous point m.1a) the values of the current of the aforementioned first line detected by means of the first current transformer located in said primary substation and transmitting the relative data with relative time references to the receiving-processing unit; m.1c) to detect through the second PMU located in the first secondary substation at certain instants of time which are the same time instants of time of the previous point m.1a) the values of the voltage at the exit of the first voltage reduction apparatus located in the first secondary substation and transmit the relative data with relative time references to the receiving-processing unit; m.1d) to detect through the third PMU located in the second secondary substation at certain instants of time which are the same time instants of time of the previous point m.1a) the values of the voltage at the exit of the second voltage reduction apparatus located in the second secondary substation and transmit the relative data with relative time references to the receiving-processing unit; m.1e) to identify by means of said receiving-processing unit among the data received at least a first instant of time in which the value of the current detected by the first current transformer is lower than a first threshold value; m.1f) to identifying by means of said receiving-processing unit among the received data the data relating to the voltage output from the measurement voltage transformer in the same first instant of time identified and selected at the previous point m.1e); m.1g) identifying by means of said receiving-processing unit among the received data the data relating to the voltage output from the first voltage reduction apparatus in the same first instant of time identified and selected in the previous point m.1e); m.1h) to process by means of the receiving-processing unit the data identified by aforementioned point m.1f) and point m.1g) regarding said first instant of time in order to obtain first calibration data for the calibration of the first voltage reduction apparatus located in the first secondary substation; m.1i) identify by means of said receiving-processing unit among the received data at least a second instant of time in which the value of the current detected by the second current transformer is lower than a first threshold value; m.1l) to identify by means of said receiving-processing unit among the received data the data relating to the voltage output from the aforementioned first voltage reduction apparatus in the same second instant of time identified and selected at the previous point m.1i); m.1m) to identifying by means of said receiving-processing unit among the received data the data relating to the voltage output from the second voltage reduction apparatus in the same second instant of time identified and selected at the previous point m.1n) to process by means of the receiving-processing unit the data identified in the previous point m.1l) and in the previous point m.1m) in association with the first calibration data of the previous point m.1h) in order to obtain second calibration data for the calibration of the second voltage reduction apparatus located in the second secondary substation.

The invention, which is characterized by the claims, solves the problem of creating a System relating a line for the distribution of electricity comprising one primary substation, a first distribution line in medium voltage, a first secondary substation and at least a second secondary substation; in which said system is characterized by the fact that said primary substation comprises: a first high voltage conductor; a HV/MV voltage transformer suitable for transforming the high voltage electrical energy coming from said first conductor into medium voltage electrical energy; a second medium voltage conductor as an output conductor from said HV/MV voltage transformer; a medium voltage busbar connected to said second medium voltage conductor; the initial portion of said first voltage medium distribution line as output line from said primary substation and connected to said voltage medium busbar; a measuring voltage transformer connected to the second conductor and suitable for measuring the output voltage from said HV/MV voltage transformer; a first current transformer connected to the first line of medium voltage in an initial zone of the same first line and able to detect the current at the beginning of the aforementioned first line of medium voltage; a first PMU connected to the output of said measurement voltage transformer and connected to the output of said current transformer; by the fact that said first secondary substation comprises: a third conductor in medium voltage as input conductor in the said first secondary substation and connected to the aforementioned first distribution line; a second current transformer connected to the first line of medium voltage in an zone between the first secondary substation and the second secondary substation and able to detect the current along the aforementioned first line of medium voltage; a first voltage reduction apparatus connected to said third conductor and able to measure the voltage entering the first secondary substation; a second PMU connected to the output of said second current transformer and to the output of said first voltage reduction apparatus; by the fact that said second secondary substation comprises: a fourth conductor in medium voltage as input conductor in the second secondary substation and connected to the aforementioned first distribution line; a second voltage reducing apparatus connected to said fourth voltage medium input conductor; a third PMU connected to the outlet of said second voltage reduction apparatus located in said second secondary substation; by the fact that said system comprises a receiving-processing unit able to receive and to process the data transmitted by the first PMU located in the primary substation, from the second PMU located in the first secondary substation and from the third PMU located in the second secondary substation.

### BRIEF DESCRIPTION OF THE DRAWINGS

Further characteristics and advantages of the present invention will be more evident from the following description of some of its preferred practical embodiments, given here purely by way of non-limiting example, made with reference to the figures of the attached drawings in which:

FIG. 1 schematically illustrates a possible pre-existing line system for the distribution of electrical energy;

FIG. 2 schematically illustrates the method and the line system object of the present invention.

### PREFERRED MANNER OF IMPLEMENTING THE INVENTION

With reference to the description of the method and of the system below, the devices meant as APMU@, ref. 51, 151, 251, 351, are known devices whose technical name in English, not yet clear as a translation into Italian, would be APhasor Measurement Units@ (acronym PMU).

These PMUs are devices that using a common time source for synchronization and measure and/or detect voltage phasor data/values and/or measure and/or detect current data/phasors and/or other parameters, to then transmit the data/values relating to the measurements and/or surveys performed, in technical terms the “phasors”, for example relating to the voltage and/or current at nominal network frequency (for example 50 Hz or 60 Hz), with associated data and now, with a very high temporal resolution, up to 120 measurements per second and with a temporal resolution of the order of tens of nanoseconds.

In this context, in relation to the protection conferred by the present invention, it means that in relation to the said one or more “PMU”, it can also be replaced with other means capable of performing the same function with respect to that which will be meant in the description, without departing from the inventive concepts protected by the present invention.

Always with reference to the descriptions given below relating to the method and system, and again in relation to the protection conferred by the present invention, it is meant that in relation to the meaning AReceiving-processing unit@ ref. UR, said device can also be replaced with other means able to perform the same function as the meaning in the description, without departing from the inventive concepts protected by the present invention.

### Preferred Forms of Implementation of the Method

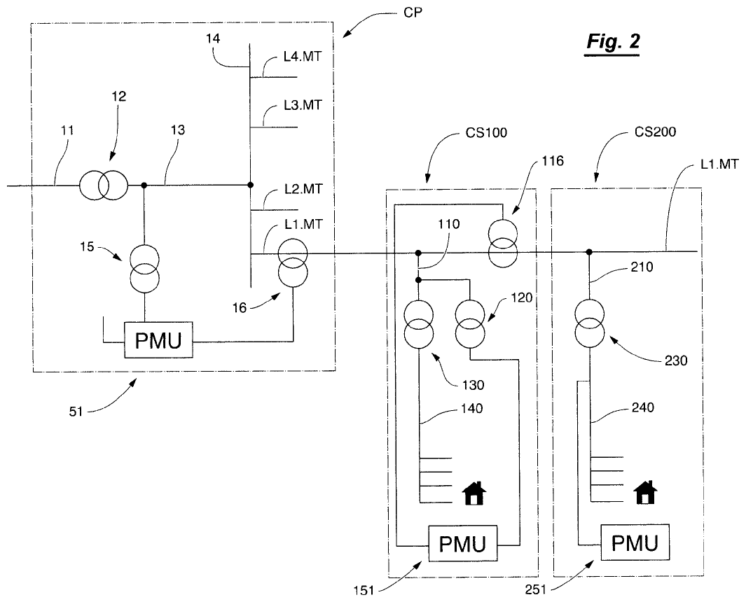

With reference to FIG. 2, the method object of the present invention is preferably applied in a grid for the distribution of electrical energy comprising: a primary substation CP; a first medium voltage distribution line L1.MT; a first secondary substation CS. 100 and at least a second secondary substation CS.200.

Again with reference to FIG. 2, the primary substation CP comprises: a first high voltage conductor 11; an HV/MV voltage transformer adapted to transform the high voltage electrical energy coming from said first conductor into medium voltage electrical energy; a second medium voltage conductor 13 as output conductor from said HV/MV voltage transformer 12; a medium voltage busbar 14 connected to said second medium voltage conductor 13; the initial portion of said first medium voltage distribution line L1.MT output from said primary substation CP and connected to said medium voltage busbar 14; a measuring voltage transformer 15 connected to the second conductor 13 and adapted to measure the output voltage from said HV/MV voltage transformer; a first current transformer 16 connected to the first medium voltage line L1.MT in an initial zone of the same first line L1.MT and adapted to detect the current at the beginning of the aforementioned first medium voltage line L1.MT; a first PMU 51 connected to the output of said voltage measuring voltage transformer 15 and to the output of said first current transformer 16.

Again with reference to FIG. 2, the first secondary substation CS.100 comprises: a third medium voltage input conductor 110 in said first secondary substation CS.100 connected to the aforementioned first distribution line L1.MT; a second current transformer 116 connected to the first medium voltage line L1.MT in a zone between the first secondary substation CS.100 and the second secondary substation CS.200 and able to detect the current along the aforementioned first line L1.MT of medium voltage; a first voltage reduction apparatus 120 connected to said third conductor 110 and adapted to measure the input voltage into the first secondary substation CS. 100; and a second PMU 151 connected to the output of said second current transformer 116 and to the output of said first voltage reduction apparatus 120.

Again with reference to FIG. 2, the second secondary substation CS.200 comprises: a fourth medium voltage input conductor 210 in said second secondary substation CS.200 connected to the aforementioned first distribution line L1.MT; a second voltage reduction apparatus 230 connected to said fourth medium voltage input conductor 210; and a third PMU 251 connected to the output of said second voltage reduction apparatus 230 located in said second secondary substation CS.200.

The system also includes a receiving-processing unit UR suitable for receiving and processing the data transmitted by the three PMUs and, more particularly, by the first PMU 51 located in the primary cabin CP, by the second PMU 151 located in the first secondary cabin CS. 100 and by the third PMU 251 located in the second secondary substation CS.200, as illustrated in the aforementioned FIG. 2.

With reference to the system described above, the method object of the present invention comprises the following operations: m.1a) to detect by means of the first PMU 51 located in the first primary substation CP at certain instants of time the values of voltage at the output of the measurement voltage transformer 15 located in the primary substation CP and transmit the relative data with relative time references to the receiving-processing unit UR; m.1b) to detect by means of the first PMU 51 located in said primary substation CP at certain instants of time which are the same instant of times of the previous point m.1a) the values of the current of the along the first line L1.MT detected by means of the first current transformer 16 located in said primary substation CP and transmitting the relative data with relative time references to the receiving-processing unit UR; m.1c) to detect by means of the second PMU 151 located in the first secondary substation CS.100 at certain instants of time which are the same time instants of time of the previous point m.1a) the values of the voltage at the exit of the first voltage reduction apparatus 120 located in the first secondary substation CS. 100 and transmit the relative data with relative time references to the receiving-processing unit UR; m.1d) to detect through the third PMU 251 located in the second secondary substation CS.200 at certain instants of time which are the same time instants of time of the previous point m.1a) the values of the voltage at the exit of the second voltage reduction apparatus 230 located in the second secondary substation CS.200 and transmit the relative data with relative time references to the receiving-processing unit UR; m.1e) to identify by means of said receiving-processing unit UR among the data received at least a first instant of time in which the value of the current detected by the first current transformer 16 is lower than a first threshold value; m.1f) to identifying by means of said receiving-processing unit UR among the received data the data relating to the voltage output from the measurement voltage transformer 15 in the same first instant of time identified and selected at the previous point m.1e); m.1g) identifying by means of said receiving-processing unit UR among the received data the data relating to the voltage output from the first voltage reduction apparatus 120 in the same first instant of time identified and selected in the previous point m.1e); m.1h) to process by means of the receiving-processing unit UR the data identified in aforementioned point m.1f) and point m.1g) regarding said first instant of time in order to obtain first calibration data for the calibration of the first voltage reduction apparatus 120 located in the first secondary substation CS.100; m.1i) identify by means of said receiving-processing unit UR among the received data at least a second instant of time in which the value of the current detected by the second current transformer 116 is lower than a first threshold value; m.1l) to identify by means of said receiving-processing unit UR among the received data the data relating to the voltage output from the aforementioned first voltage reduction apparatus 120 in the same second instant of time identified and selected at the previous point m.1i); m.1m) to identifying by means of said receiving-processing unit UR among the received data the data relating to the voltage output from the second voltage reduction apparatus 230 in the same second instant of time identified and selected at the previous point m.1i); m.1n) t^{∘} process by means of the receiving-processing unit UR the data identified in the previous point m.1l), relating to the voltage output from the aforementioned first voltage reduction apparatus 120, and the data identified in the previous point m.1m), relating to the voltage output from the second voltage reduction apparatus 230, in association with the first calibration data of the previous point m.1h), in order to obtain second calibration data for the calibration of the second voltage reduction apparatus 230 located in the second secondary substation CS.200.

Again with reference to the system described above, the method object of the present invention can also comprise the following operations: m.2a) to storing by means of the receiving-processing unit UR the data transmitted by the first PMU 151 and by the second PMU 251; m.2b) to identify and select by means of said receiving-processing unit UR among the received data at least a second instant of time in which the current value relating to the first line L1.MT detected by the second current transformer 116 located in the first secondary substation CS.100 is lower than a first threshold value; m.2c) to identify by means of said receiving-processing unit UR and among the received data the data relating to the voltage output with respect to the first voltage reduction apparatus 120 located in the first secondary substation CS. 100 in the same second instant of time identified and selected at the above point m.2b); m.2d) to identify by means of said receiving-processing unit UR among the received data the data concerning the output voltage with respect to the second voltage reduction apparatus 230 located in the second secondary substation CS. 200 in the same second instant of time identified and selected in the above point m.2b); m.2e) to process by means of the receiving-processing unit UR the data identified in point m.2c), concerning the output voltage with respect to the first voltage reduction apparatus 120, the data identified in point m.2d), concerning the output voltage with respect to the second voltage reduction apparatus 230, in association with the first calibration data of the previous point m.1h), as data for the calibration of the first voltage reduction apparatus 120 located in the first secondary substation CS. 100, in order to perform a calibration in relation to the second voltage reduction apparatus 230 located in the second secondary substation CS.200 and, therefore, for example, obtain the true value of the voltage at the output of the second voltage reduction apparatus 230.

Again by the system described above, the method object of the present invention can also include the following operations: m.3a) to storing by means of the receiving-processing unit UR the data transmitted by the first PMU 151 and by the second PMU 251; m.3b) to identify and to select by means of said receiving-processing unit UR among the received data at least a second instant of time in which the current value relating to the first line L1.MT detected by the second current transformer 116 located in the first secondary substation CS. 100 is lower than a first threshold value; m.3c) to identify by means of said receiving-processing unit UR among the received data a first voltage value regarding the output voltage with respect to the first voltage reduction apparatus 120 located in the first secondary substation CS. 100 in the same second instant of time identified and selected in the aforementioned point m.3b); m.3d) to identify by means of said receiving-processing unit UR among the received data a second voltage value regarding the output voltage with respect to the second voltage reduction apparatus 230 located in the second secondary substation CS.200 in the same second instant of time identified and selected in the aforementioned point m.3b); m.3e) to process by means of the receiving-processing unit UR said first voltage value of the aforementioned point m.3c), regarding the output voltage with respect to the first voltage reduction apparatus 120, in association with said first calibration data relating to the first voltage reduction apparatus 120 of the above point m.1h), in order to obtain a third correct voltage value (so-called true value) relative to said first voltage reduction apparatus (120); m.3f) compare by means of the receiving-processing unit UR said third voltage value corrected value (so-called true value) of the previous point m.3e), regarding the output voltage with respect to the first voltage reduction apparatus 120, with the second voltage value of the previous point m.3d), regarding the output voltage with respect to the second voltage reduction apparatus 230, in order to perform the calibration of the second voltage reduction apparatus 230 located in the second secondary substation CS.200, that is to obtain the true value of the voltage at the output of the second voltage reduction apparatus 230.

Always with reference to the method described above, the aforementioned first instant in time and the aforementioned second instant in time can be the same instant in time, or two distinct instants of time that do not fall in the same instant in time, i.e. two instants of time temporally spaced apart.

Again with reference to the method described above, the first predetermined threshold value mentioned in the present description, see in particular but not exclusively the aforementioned points m.1e), m.1i), m.2b) and m.3b), it is preferably equal to zero, or, always preferably, equal to a value such as to have a negligible effect due to the voltage drop on the first line due to the current flowing in the first line itself. This current value can for example be determined on the basis of the length of the first line L1.MT.

### Preferred Forms of Implementation of the System

With reference to FIG. 2, the system relating to a line for the distribution of electrical energy object of the present invention comprises: a primary substation CP; a first medium voltage distribution line L1.MT; a first secondary substation CS.100; and at least a second secondary substation CS.200.

Again with reference to FIG. 2, the primary substation CP comprises: a first high voltage conductor 11; an HV/MV voltage transformer 12 adapted to transform the high voltage electrical energy coming from said first conductor 11 into medium voltage electrical energy; a second medium voltage conductor 13 as output conductor from said HV/MV voltage transformer 12; a medium voltage busbar 14 connected to said second medium voltage conductor 13; the initial portion of said first medium voltage distribution line L1.MT at output from said primary substation CP connected to said medium voltage busbar 14; a measuring voltage transformer 15 connected to the second conductor 13 and adapted to measure the output voltage from said HV/MV voltage transformer 12; a first current transformer 16 connected to the first medium voltage line L1.MT in an initial zone of the same first line L1.MT and adapted to detect the current at the beginning of the aforementioned first medium voltage line L1.MT; and a first PMU 51 connected to the output of said voltage measuring voltage transformer 15 and to the output of said first current transformer 16.

Always with reference to FIG. 2, the first secondary substation CS.100 comprises: a third medium voltage input conductor 110 in said first secondary substation CS.100 connected to the aforementioned first distribution line L1.MT; a second current transformer 116 connected to the first medium voltage line L1.MT in a zone between the first secondary substation CS.100 and the second secondary substation CS.200 and able to detect the current along the aforementioned first line L1.MT of medium voltage; a first voltage reduction apparatus 120 connected to said third conductor 110 and adapted to measure the input voltage into the first secondary substation CS. 100; a second PMU 151 connected to the output of said second current transformer 116 and to the output of said first voltage reduction apparatus 120.

Again with reference to FIG. 2, the second secondary substation CS.200 comprises: a fourth medium voltage input conductor 210 in said second secondary substation CS.200 connected to the aforementioned first distribution line L1.MT; a second voltage reduction apparatus 230 connected to said fourth medium voltage input conductor 210; a third PMU 251 connected to the output of said second voltage reduction apparatus 230 located in said second secondary substation CS.200.

The system described above also comprises a receiving-processing unit UR suitable for receiving and processing the data transmitted by the three PMUs and, more particularly, by the first PMU 51 located in the primary cabin CP; from the second PMU 151 located in the first secondary substation CS. 100 and from the third PMU 251 located in the second secondary substation CS.200.

With reference to the system described above, it can be configured to perform the following operations: s.2a) by means of the first PMU 51 located in the first primary substation CP, to detect at certain instants of time the values of voltage at the output of the measurement voltage transformer 15 located in the primary substation CP and transmit the relative data with relative time references to the receiving-processing unit UR; s.2b) by means of the first PMU 51 located in said primary substation CP, to detect at certain instants of time which are the same instant of times of the previous point s.2a) the values of the current of the aforementioned first line L1.MT detected by means of the first current transformer 16 located in said primary substation CP and transmitting the relative data with relative time references to the receiving-processing unit UR; s.2c) by the second PMU 151 located in the first secondary substation CS. 100, to detect at certain instants of time which are the same time instants of time of the previous point s.2a) the values of the voltage at the exit of the first voltage reduction apparatus 120 located in the first secondary substation CS.100 and transmit the relative data with relative time references to the receiving-processing unit UR; s.2d) by the third PMU 251 located in the second secondary substation CS.200 to detect at certain instants of time which are the same time instants of time of the previous point s.2a) the values of the voltage at the exit of the second voltage reduction apparatus 230 located in the second secondary substation CS.200 and transmit the relative data with relative time references to the receiving-processing unit UR; s.2e) by means of said receiving-processing unit UR to identify among the data received at least a first instant of time in which the value of the current detected by the first current transformer 16 is lower than a first threshold value; s.2f) by means of said receiving-processing unit UR to identifying among the received data the data relating to the voltage output from the measurement voltage transformer 15 in the same first instant of time identified and selected at the previous point s.2e); s.2g) by means of said receiving-processing unit UR to identifying among the received data the data relating to the voltage output from the first voltage reduction apparatus 120 in the same first instant of time identified and selected in the previous point s.2e); s.2h) by means of the receiving-processing unit UR to process the data identified in the aforementioned point s.2f), relating to the voltage output from the measurement voltage transformer 15, the data identified in the aforementioned point s.2g), relating to the voltage output from the first voltage reduction apparatus 120, both regarding said first instant of time, in order to obtain first calibration data for the calibration of the first voltage reduction apparatus 120 located in the first secondary substation CS. 100; s.2i) by means of said receiving-processing unit UR to identify among the received data at least a second instant of time in which the value of the current detected by the second current transformer 116 is lower than a first threshold value; s.2l) by means of said receiving-processing unit UR to identify among the received data the data relating to the voltage output from the aforementioned first voltage reduction apparatus 120 in the same second instant of time identified and selected at the previous point s.2i); s.2m) by means of said receiving-processing unit UR to identifying among the received data the data relating to the voltage output from the second voltage reduction apparatus 230 in the same second instant of time identified and selected at the previous point s.2l); s.2n) by means of the receiving-processing unit UR to process the data identified in the previous point s.2l), relating to the voltage output from the aforementioned first voltage reduction apparatus 120, the data identified in the previous point s.2m), relating to the voltage output from the second voltage reduction apparatus 230, in association with the first calibration data of the previous point s.2h), in order to obtain second calibration data for the calibration of the second voltage reduction apparatus 230 located in the second secondary substation CS.200.

Again with reference to the system described above, it can be configured to perform the following operations: s.3a) by means of the receiving-processing unit UR to storing the data transmitted by the first PMU 151 and by the second PMU 251; s.3b) by means of said receiving-processing unit UR to identify and select among the received data at least a second instant of time in which the current value relating to the first line L1.MT detected by the second current transformer 116 located in the first secondary substation CS. 100 is lower than a first threshold value; s.3c) by means of said receiving-processing unit UR to identify among the received data the data relating to the voltage output with respect to the first voltage reduction apparatus 120 located in the first secondary substation CS. 100 in the same second instant of time identified and selected at the above point s.3b); s.3d) by means of said receiving-processing unit UR to identify among the received data the data concerning the output voltage with respect to the second voltage reduction apparatus 230 located in the second secondary substation CS.200 in the same second instant of time identified and selected in the above point s.3b); s.3e) by means of the receiving-processing unit UR to process the data identified in the aforementioned point s.3c), relating to the voltage output with respect to the first voltage reduction apparatus 120, the data identified in the aforementioned point s.3d), concerning the output voltage with respect to the second voltage reduction apparatus 230, in association with the first calibration data of the previous point s.2h), in order to perform a calibration in relation to the second voltage reduction apparatus 230 located in the second secondary substation CS.200 and, therefore, for example, obtain the true value of the voltage at the output of the second voltage reduction apparatus 230.

Again with reference to the system described above, it can be configured to perform the following operations: s.4a) by means of the receiving-processing unit UR to storing the data transmitted by the first PMU 151 and by the second PMU 251; s.4b) by means of said receiving-processing unit UR to identify and to select among the received data at least a second instant of time in which the current value relating to the first line L1.MT detected by the second current transformer 116 located in the first secondary substation CS. 100 is lower than a specific first threshold value; s.4c) by means of said receiving-processing unit UR to identify among the received data a first voltage value regarding the output voltage with respect to the first voltage reduction apparatus 120 located in the first secondary substation CS.100 in the same second instant of time identified and selected in the above point s.4b); s.4d) by means of said receiving-processing unit UR to identify among the received data a second voltage value regarding the output voltage with respect to the second voltage reduction apparatus 230 located in the second secondary substation CS.200 in the same second identified instant of time selected in the above point s.4b); s.4e) by means of the receiving-processing unit UR to process said first voltage value of above point s.4c), regarding the output voltage with respect to the first voltage reduction apparatus 120, in association with said first calibration data relating to the first voltage reduction apparatus 120 of above point s.2h), in order to obtain a third corrected voltage value (so-called true value) relating to said first voltage reduction apparatus 120; s.4f) by means of the receiving-processing unit UR compare said third voltage value corrected (so-called true value) of the previous point 4.e) with the second voltage value of the previous point s.4d) in order to perform the calibration of the second voltage reduction apparatus 230 located in the second secondary substation CS. 200, i.e. obtain the true value of the voltage at the output of the second voltage reduction apparatus 230.

Always with reference to the system described above, the aforementioned first instant of time and the aforementioned second instant of time can be the same instant of time, or two distinct instants of time which do not fall into the same instant of time, i.e. two instants of time temporally spaced apart.

Again with reference to the system described above, the first predetermined threshold value mentioned in the present description, see in particular but not exclusively points s.2e), s.2i), s.3b) and s.4b), above, it is preferably equal to zero, or, always preferably, equal to a value such as to have a negligible effect due to the voltage drop on the first line due to the current flowing in the first line itself. This current value can for example be determined on the basis of the length of the first line L1.MT.

### First Threshold Value Regarding Method and System

With reference to the above description and examples, in relation to the calibration of one or more voltage reduction apparatuses 120/130/230/320, preferably, the method and/or system described above is particularly effective when the value of the current relative to the first line L1.MT detected by means of the current transformer 16 located in the primary substation CP is lower than a given first predetermined threshold value and, preferably, when said first threshold value is equal to zero (optimal value).

With reference to said first threshold value of the current not to be exceeded detected by the current transformer 16, by way of non-limiting example, it can be determined in correlation with the components that are applied along the line L1.MT and, in any case, this first threshold value must have a measure such as to have an effect due to the voltage drop on the line L1.MT due to the effect of the current flowing in the line M1.MT having a negligible amount.

According to a first form of determination, if the value of said voltage detected by means of the precision TV 15 is equal to 100 kV effective Volt and if in the first secondary substation CS.100 there is a voltage reduction apparatus 130 as a capacitive divider type having the following characteristics, rated voltage 10 kV and accuracy class 0.5 (i.e. maximum ratio error 0.5% of the rated voltage and maximum phase error equal to 0.6 crad in the range 80%-120% of the rated voltage-values in accordance with the reference standard IEC 61869-1), said first threshold value of the current that not to be exceeded will be such as not to cause a voltage drop along the line not exceeding a fraction of the ratio error associated with accuracy class 0.5, i.e. 0.5% of 10 kV=50V rms. Jt is common among calibration laboratories to consider this fraction of the ratio error variable between ⅓ and ⅕ of the accuracy class, that is, in the example cited, between 0.1% and 0.2% which, in absolute value, corresponds at an interval between 10V and 20V. Therefore, the drop along the line caused by the current must not exceed, for example, 20V. 1f, according to the tables of the characteristics of the medium voltage cables used on the market, a series resistance of the cable of 0.2 ohm/km is assumed, with reference to 10 km of length the current must be less than 10A in order not to exceed 20V of drop.

In this context, this first predetermined threshold value is preferably a value such as to have an effect due to the voltage drop on the first line L1.MT having an entity equal to or less than ⅓ of the ratio error associated with the accuracy class of a voltage reduction apparatus, for example 130, to be calibrated.

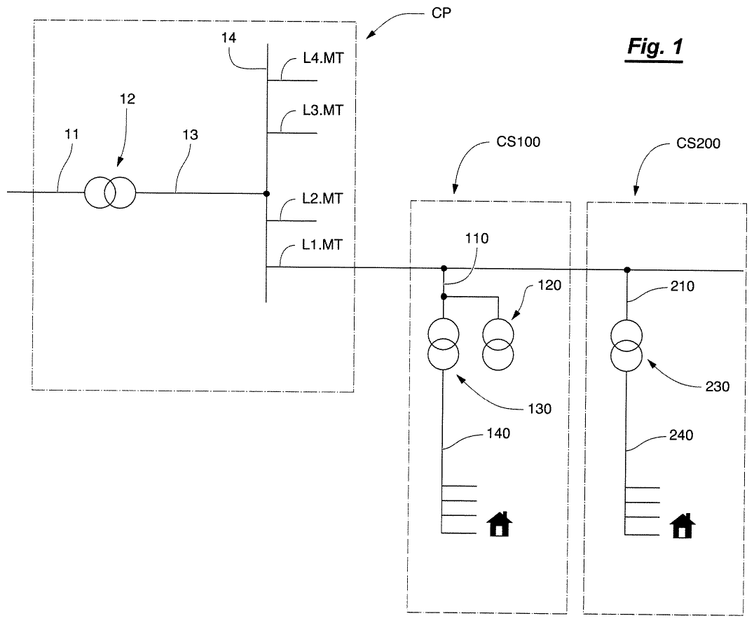

By means of the method and/or system object of the present invention it is possible to perform a calibration in relation to one or more voltage reduction apparatuses located in a secondary substation or in other secondary substations, solving the above mentioned problems. Furthermore, again by means of the method and/or system object of the present invention, it is possible to modify existing grid systems, such as for example the systems illustrated in FIG. 1, in which it is not possible to carry out diagnostics of the devices, in grid systems in which it is possible to carry out the diagnostics of the devices, through the execution of no expensive works about cost for the execution time, as they require the insertion of a few components, as well as no expensive works, as it is not required to modify the pre-existing system, and also no expensive as components to be added, solving the above problems.

The descriptions of the above method and of the above system are given by way of example only and not by way of limitation and, therefore, it is clear that said method and said system may be subject to any changes or variations suggested by the practice and their implement or use and, in any event, within the scope of the following claims, in which this claims form an additional and/or complementary part for this description.

01. A method for a system of a line for the distribution of electricity, the system comprising:
a primary substation;
a first distribution line in medium voltage;
a first secondary substation;
at least a second secondary substation;
the primary substation having
a first high voltage conductor;
an HV/MV voltage transformer suitable for transforming the high voltage electrical energy coming from said first conductor into medium voltage electrical energy;
a second medium voltage conductor as an output conductor from said HV/MV voltage transformer;
a medium voltage busbar connected to said second medium voltage conductor, an initial portion of said first voltage medium distribution line serving as output line from said primary substation and connected to said voltage medium busbar;
a measuring voltage transformer connected to the second conductor and suitable for measuring the output voltage from said HV/MV voltage transformer;
a first current transformer connected to the first line of medium voltage in the initial portion of the same first line and able to detect the current at the initial portion of said first line of medium voltage; and
a first PMU connected to the output of said measurement voltage transformer and connected to the output of said first current transformer;
the first secondary substation having
a third conductor in medium voltage as input conductor in said first secondary substation and connected to the first distribution line;
a second current transformer connected to the first line of medium voltage in a n zone between the first secondary substation and the second secondary substation and able to detect the current along said first line of medium voltage;
a first voltage reduction apparatus connected to said third conductor and able to measure the voltage entering the first secondary substation; and
a second PMU connected to an output of said second current transformer and to the output of said first voltage reduction apparatus' the second secondary substation having
a fourth conductor in medium voltage as input conductor in the second secondary substation and connected to the first distribution line;
a second voltage reducing apparatus connected to said fourth voltage medium input conductor; and
a third PMU connected to an outlet of said second voltage reduction apparatus located in said second secondary substation;
the system further comprising:
a receiving-processing unit able to receive and to process the data transmitted by the first PMU in the primary substation, by the second PMU in the first secondary substation and by the third PMU in the second secondary substation the method comprising the steps of:
1a) detecting with the first PMU in the first primary substation at certain instants of time the values of voltage at an output of the measurement voltage transformer in the primary substation and transmit the relative data with relative time references to the receiving-processing unit;
1b) detecting with the first PMU in said primary substation at certain instants of time that are the same instant of times of the step 1a) the values of the current of the first line detected by means of the first current transformer said primary substation and transmitting the relative data with relative time references to the receiving-processing unit;
1c) detecting with the second PMU in the first secondary substation at certain instants of time that are the same time instants of time of the step 1a) the values of the voltage at an output of the first voltage reduction apparatus in the first secondary substation and transmit the relative data with relative time references to the receiving-processing unit;
1d) detecting with the third PMU in the second secondary substation at certain instants of time that are the same time instants of time of the step 1a) the values of the voltage at the exit of the second voltage reduction apparatus in the second secondary substation and transmitting the relative data with relative time references to the receiving-processing unit;
1e) identifying with the receiving-processing unit among the data received at least a first instant of time in which the value of the current detected by the first current transformer is lower than a first threshold value;
1f) identifying with the receiving-processing unit among the received data the data relating to the voltage output from the measurement voltage transformer in the same first instant of time identified and selected at the step 1e);
1g) identifying with the receiving-processing unit among the received data the data relating to the voltage output from the first voltage reduction apparatus in the same first instant of time identified and selected in the step 1e);
1h) processing with the receiving-processing unit the data identified in step 1f) and step 1g) regarding said first instant of time in order to obtain first calibration data for the calibration of the first voltage reduction apparatus in the first secondary substation;
1i) identifying with the receiving-processing unit among the received data at least at a second instant of time in which the value of the current detected by the second current transformer is lower than a first threshold value;
1l) identifying with the receiving-processing unit among the received data the data relating to the voltage output from the first voltage reduction apparatus in the same second instant of time identified and selected in the step 1i);
1m to identifying with the receiving-processing unit among the received data the data relating to the voltage output from the second voltage reduction apparatus in the same second instant of time identified and selected at the step 1i); and
1n) processing with the receiving-processing unit the data identified in the step 1l) and in the step 1m) in association with the first calibration data of the step 1h) in order to obtain second calibration data for the calibration of the second voltage reduction apparatus in the second secondary substation.

02. The method according to claim 1, further comprising the steps of:
2a) storing with the receiving-processing unit the data transmitted by the first PMU and by the second PMU;
2b) identifying and selecting with the receiving-processing unit among the received data at least a second instant of time in which the current value relating to the first line detected by the second current transformer in the first secondary substation is lower than a first threshold value;
2c) identifying with the receiving-processing unit and among the received data the data relating to the voltage output with respect to the first voltage reduction apparatus in the first secondary substation in the same second instant of time identified and selected in step 2b);
2d) identifying with the receiving-processing unit among the received data the data concerning the output voltage with respect to the second voltage reduction apparatus in the second secondary substation in the same second instant of time identified and selected in step 2b); and
2e) processing with the receiving-processing unit the data identified in step 2c) and in step 2d) in association with the first calibration data of the step 1h) in order to perform a calibration in relation to the second voltage reduction apparatus in the second secondary substation.

03. The method according to claim 1, further comprising the steps of:
3a) storing the receiving-processing unit the data transmitted by the first PMU and by the second PMU;
3b) identifying and to selecting with the receiving-processing unit among the received data at least a second instant of time in which the current value relating to the first line detected by the second current transformer in the first secondary substation is lower than a first threshold value;
3c) identifying with the receiving-processing unit among the received data a first voltage value regarding the output voltage with respect to the first voltage reduction apparatus in the first secondary substation in the same second instant of time identified and selected in the above step 3b);
3d) identifying with the receiving-processing unit among the received data a second voltage value regarding the output voltage with respect to the second voltage reduction apparatus in the second secondary substation in the same second instant of time identified and selected in the above step 3b);
3e) processing with the receiving-processing unit said first voltage value of the step 3c) in association with said first calibration data relating to the first voltage reduction apparatus of the step 1h), in order to obtain a third corrected voltage value relating to said first voltage reduction apparatus; and
3f) the receiving-processing unit comparing said third voltage value corrected in step 3e) with the second voltage value step 3d) in order to perform the calibration of the second voltage reduction apparatus in the second secondary substation.

04. The method according to claim 01, wherein the first threshold value is preferably equal to zero.

05. The method according to claim 01, wherein the first threshold value is a value so as to have a negligible effect due to voltage drop on the first line.

06. The method according to claim 01, wherein the first threshold value is a value such as to have an effect due to the voltage drop on the first line having an entity equal to or less than ⅓ of a ratio error associated with an accuracy class of a voltage reduction apparatus to be calibrated.

07. A system for a line for the distribution of electricity comprising:
a primary substation;
a first distribution line in medium voltage;
a first secondary substation;
at least a second secondary substation;
the primary substation having
a first high voltage conductor;
an HV/MV voltage transformer suitable for transforming the high voltage electrical energy coming from said first conductor into medium voltage electrical energy;
a second medium voltage conductor serving as an output conductor from said HV/MV voltage transformer;
a medium voltage busbar connected to said second medium voltage conductor 13, and initial portion of said first voltage medium distribution line serving as output line from said primary substation and connected to said voltage medium busbar;
a measuring voltage transformer connected to the second conductor and suitable for measuring the output voltage from said HV/MV voltage transformer;
a first current transformer connected to the first line of medium voltage in the initial portion of the first line and able to detect the current at the initial portion of the first line of medium voltage; and
a first PMU connected to the output of said measurement voltage transformer and connected to the output of said current transformer;
the first secondary substation having
a third conductor in medium voltage as input conductor in the first secondary substation and connected to the first distribution line;
a second current transformer connected to the first line of medium voltage in a zone between the first secondary substation and the second secondary substation and able to detect the current along the first line of medium voltage;
a first voltage reduction apparatus connected to said third conductor and able to measure the voltage entering the first secondary substation; and
a second PMU connected to the output of said second current transformer and to the output of said first voltage reduction apparatus;
the second secondary substation having
a fourth conductor in medium voltage as input conductor in the second secondary substation and connected to the first distribution line;
a second voltage reducing apparatus connected to said fourth voltage medium input conductor; and
a third PMU connected to the outlet of said second voltage reduction apparatus in said second secondary substation;
the system further comprising
a receiving-processing unit able to receive and to process the data transmitted by the first PMU in the primary substation, from the second PMU in the first secondary substation and from the third PMU located in the second secondary substation.

08. The system according to claim 7, wherein the system is configured to perform the following operations:
2a) the first PMU in the first primary substation detecting the values of voltage at an output of the measurement voltage transformer in the primary substation and transmit the relative data with relative time references to the receiving-processing unit;
2b) the first PMU in said primary substation detecting at certain instants of time that are the same instant of times of step 2a) the values of the current of the first line detected the first current transformer in said primary substation and transmitting the relative data with relative time references to the receiving-processing unit;
2c) the second PMU in the first secondary substation detecting at certain instants of time that are the same time instants of time of step 2a) the values of the voltage at an output of the first voltage reduction apparatus in the first secondary substation and transmitting the relative data with relative time references to the receiving-processing unit;
2d) the third PMU in the second secondary substation detecting at certain instants of time which that are the same time instants of time of step 2a) the values of the voltage at an output of the second voltage reduction apparatus in the second secondary substation and transmitting the relative data with relative time references to the receiving-processing unit;
2e) the receiving-processing unit identifying among the data received at least a first instant of time in which the value of the current detected by the first current transformer is lower than a first threshold value;
2f) the receiving-processing unit identifying among the received data the data relating to the voltage output from the measurement voltage transformer in the same first instant of time identified and selected in step 2e);
2g) the receiving-processing unit identifying among the received data the data relating to the voltage output from the first voltage reduction apparatus in the same first instant of time identified and selected in step 2e);
2h) the receiving-processing unit processing data identified in step 2f) and in point step 2g) regarding said first instant of time in order to obtain first calibration data for the calibration of the first voltage reduction apparatus in the first secondary substation;
2i) the receiving-processing unit identifying among the received data at least a second instant of time in which the value of the current detected by the second current transformer is lower than a first threshold value;
2l. the receiving-processing unit identifying among the received data the data relating to the voltage output from the first voltage reduction apparatus in the same second instant of time identified and selected in step 2i);
2m) the receiving-processing unit identifying among the received data the data relating to the voltage output from the second voltage reduction apparatus in the same second instant of time identified and selected at the in step 2i); and
2n) the receiving-processing unit processing the data identified in step 2l) and in step 2m) in association with the first calibration data of step 2h) in order to obtain second calibration data for the calibration of the second voltage reduction apparatus in the second secondary substation.

09. The system according to claim 7, where the system is configured to perform the following steps:
3a) the receiving-processing unit storing the data transmitted by the first PMU and by the second PMU;
3b) the receiving-processing unit identifying and selecting among the received data at least at a second instant of time in which the current value relating to the first line detected by the second current transformer in the first secondary substation is lower than a first threshold value;
3c) the receiving-processing unit identifying among the received data the data relating to the voltage output with respect to the first voltage reduction apparatus in the first secondary substation in the same second instant of time identified and selected in step 3b);
3d) the receiving-processing unit identifying among the received data the data concerning the output voltage with respect to the second voltage reduction apparatus in the second secondary substation in the same second instant of time identified and selected in step 3b); and
3e) the receiving-processing unit processing the data identified in step 3c) and in step 3d) in association with the first calibration data of step 2h) in order to perform a calibration in relation to the second voltage reduction apparatus in the second secondary substation.

10. The system according to claim 07, wherein the system is configured to perform the following steps:
4a) the receiving-processing unit to storing the data transmitted by the first PMU and by the second PMU;
4b) the receiving-processing unit identifying and to selecting among the received data at least a second instant of time in which the current value relating to the first line detected by the second current transformer in the first secondary substation is lower than a specific first threshold value;
4c) the receiving-processing unit identifying among the received data a first voltage value regarding the output voltage with respect to the first voltage reduction apparatus in the first secondary substation in the same second instant of time identified and selected in step 4b);
4d) the receiving-processing unit identifying among the received data a second voltage value regarding the output voltage with respect to the second voltage reduction apparatus in the second secondary substation in the same second identified instant of time selected in step 4b);
4e) the receiving-processing unit to processing said first voltage value of step 4c) in association with said first calibration data relating to the first voltage reduction apparatus of step 2h), in order to obtain a third corrected voltage value relating to said first voltage reduction apparatus;
4f) the receiving-processing unit comparing said third voltage value of step 4e) with the second voltage value of step 4d) in order to perform the calibration of the second voltage reduction apparatus in the second secondary substation.

11. The system according to claim 07, wherein the first predetermined threshold value is preferably equal to zero.

12. The system according to claim 07, wherein the first predetermined threshold value is a value having a negligible effect due to the voltage drop on the first line.

13. The system according to claim 07, wherein the first threshold value is a value having an effect due to the voltage drop on the first line having an entity equal to or less than ⅓ of a ratio error associated with an accuracy class of a voltage reduction apparatus to be calibrated.
